(19) United States
(12) Patent Application Publication
(10) Pub. No.: US 2015/0107757 A1
(43) Pub. Date: Apr. 23, 2015

(54) METHODS AND KITS FOR TRANSFERRING AN IMAGE ONTO A SURFACE

(71) Applicant: David Fuss, Chapel Hill, NC (US)

(72) Inventor: David Fuss, Chapel Hill, NC (US)

(21) Appl. No.: 14/517,864

(22) Filed: Oct. 19, 2014

Related U.S. Application Data
(60) Provisional application No. 61/894,517, filed on Oct. 23, 2013.

(51) Int. Cl. B32B 38/00

(52) U.S. Cl. CPC B32B 38/145; B32B 2451/00
USPC 156/155

(57) ABSTRACT

Methods and kits for transferring an image onto a surface are disclosed. According to an aspect, a method for placing an image on a surface includes printing an image on a dissolving material, such as dissolving paper. The method includes applying clear gel to the printed image. Further, the method includes applying liquid to the dissolving material to remove the dissolving material from the printed image. The method also includes coating a backside of the printed image with adhesive. Further, the method includes contacting the adhesive-covered backside of the printed image to a surface, such as a surface of a stone, wood, glass, mirror, plastic, foam, or metal.

### CROSS REFERENCE TO RELATED APPLICATION

This application claims priority to U.S. Provisional Patent Application No. 61/894,517, filed Oct. 23, 2013 and titled METHODS AND KITS FOR TRANSFERRING AN IMAGE ONTO A SURFACE, the disclosure of which is incorporated herein by reference in its entirety.

### BACKGROUND

1. Technical Field

The present subject matter relates to imaging. More particularly, the present subject matter relates to methods and kits for transferring an image onto a surface.

2. Description of Related Art

Cameras and mobile phones are often used to digitally capture images. Subsequently, a digital image may be printed on paper, framed, and displayed for view. In some instances, it may be desired to place an image on an object other than paper in order to provide a more unique and visually-appealing display of the image. For this reason, it is desired to provide techniques for transferring images onto a desired surface.

### BRIEF SUMMARY

In accordance with one or more embodiments of the present subject matter, methods and kits for transferring an image onto a surface are disclosed. According to an aspect, a method for placing an image on a surface includes printing an image on a dissolving material, such as dissolving paper. The method includes applying clear gel to the printed image. Further, the method includes applying liquid to the dissolving material to remove the dissolving material from the printed image. The method also includes coating a backside of the printed image with adhesive. Further, the method includes contacting the adhesive-covered backside of the printed image to a surface, such as a surface of a stone, wood, foam, glass, mirror, plastic or metal. According to an aspect, a kit for placing an image on a surface includes dissolving material for transfer of an image. Further, the kit includes clear gel for application to the image printed on the dissolving material. The kits also includes adhesive for attaching the printed image to a surface.

### BRIEF DESCRIPTION OF THE SEVERAL VIEWS OF THE DRAWINGS

FIGS. 1-14 depict different views of example steps in a method of printing an image on a surface in accordance with embodiments of the present subject matter; and

FIG. 15 depicts a perspective the stone with the image placed thereon in a display stand.

### DETAILED DESCRIPTION

As described herein, there are various embodiments and aspects of the present subject matter. According to embodiments, the present subject matter is directed to methods and kits for printing an image on a surface.

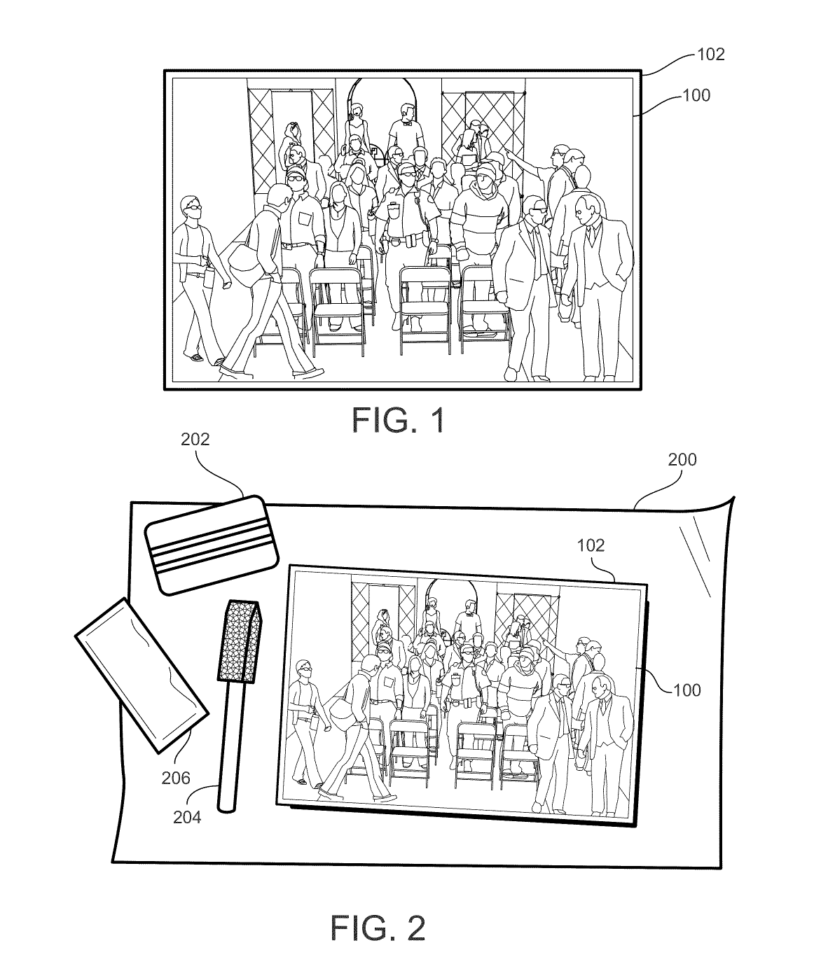

FIGS. 1-14 depicts different views of example steps in a method of transferring an image onto a surface in accordance with embodiments of the present subject matter. Items needed for this example method may include, but are not limited to, a kit in accordance with the present subject matter, a hair dryer or other suitable drying equipment, paper towels or other absorbent material, scissors, water, and protective material such as wax paper or aluminum foil. The kit may include the following: an 8.5 inch×11 inch sheet of dissolving paper, a squeegee, a ½ inch foam brush, a 20 ml packet of clear gel. The clear gel may be, for example, any suitable acrylic gel medium, polyvinyl acetate glue, or the like. Other examples include, but are not limited to, acrylic gesso, acrylic matte medium, acrylic gloss medium or any other substance that is mostly acrylic based. The kit may also include a 10 ml packet of clear gel, which may be, for example, an acrylic gel medium or polyvinyl acetate glue. Alternative examples include, but are not limited to, acrylic gesso, acrylic matte medium, acrylic gloss medium or any other substance that is mostly acrylic based. Further, the kit may include a hand chipped stone or other object to print to (e.g., wood, foam, glass, mirror, metal, plastic, or the like), a display stand, and a sponge. The materials may be laid out on a clean, dry table.

Referring to FIG. 1, the figure depicts a top view of a result of printing an image 100 on a dissolving material or paper 102. This can be an initial step in the example method. In this example, the dissolving material 102 is dissolving paper, although it should be understood that any other suitable type of dissolving material may be used. As an example, regular printer paper or cardstock can be used as the dissolving material 102. In this case, the paper may need to be separated from the dried acrylic gel. Separation of the paper from the gel can mostly or entirely be done by wetting, rubbing, and/or any other suitable technique. This process can take much longer than if using the dissolving paper. In this example, a laser printer is used to print an image to an 8.5 inch×11 inch sheet of dissolving paper, or any other suitably sized sheet. The image 100 may be printed in color or black and white. In this example, the image 100 is printed as a full page, although it may be printed to the paper in any suitable size.

FIG. 2 depicts top view of the dissolving material or paper 102 with the image 100 printed thereon. Referring to FIG. 2, the paper 102 is placed on top of a sheet of aluminum foil 200 along with a squeegee 202, a foam brush 204, and a 20 ml packet 206 of clear gel. The aluminum foil 200 can protect the working surface (e.g., table surface) from the gel used in accordance with embodiments of the present subject matter. Alternative to the aluminum foil 200, any other suitable material may be used for protecting the working surface.

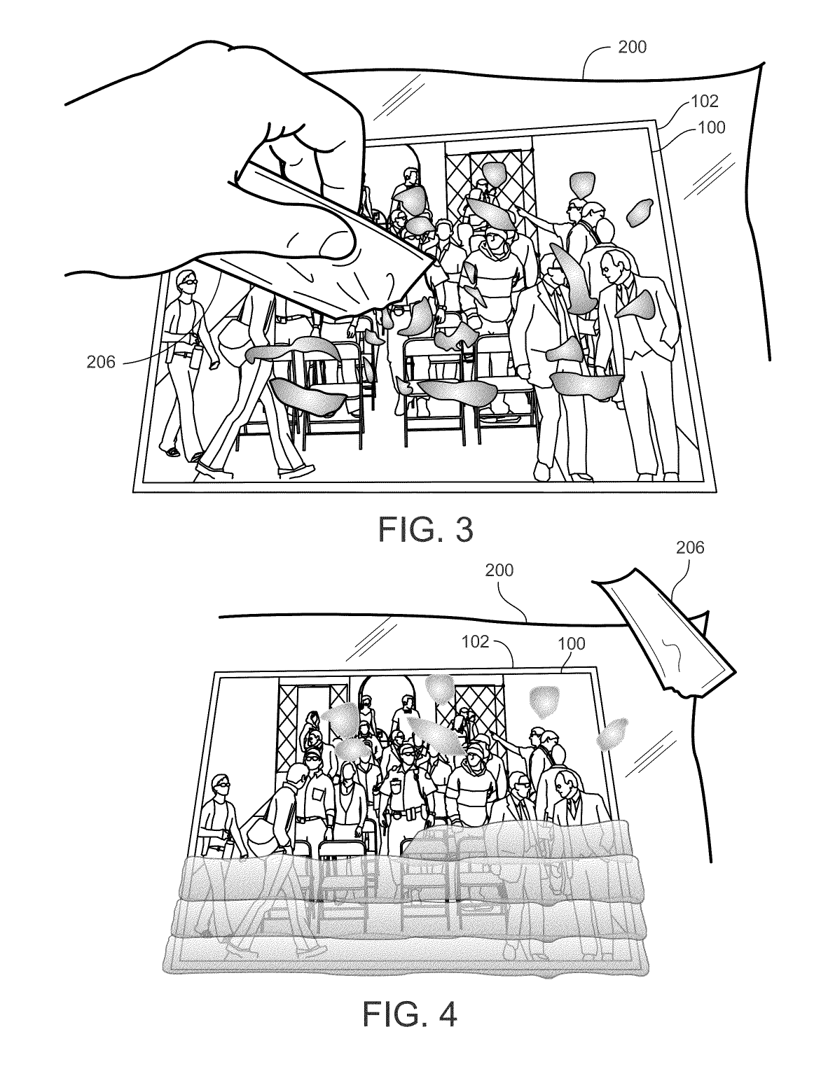

FIG. 3 depicts a perspective view of the clear gel in the 20 ml packet 206 being applied to the picture side of the dissolving paper in accordance with embodiments of the present subject matter. Subsequently, the foam brush 204 can be used to evenly or substantially evenly paint the clear gel on the image 100 until the entirety or substantially all of the paper 102 is covered as shown in FIG. 4. The paper 102 may be covered by the gel to the paper's edges.

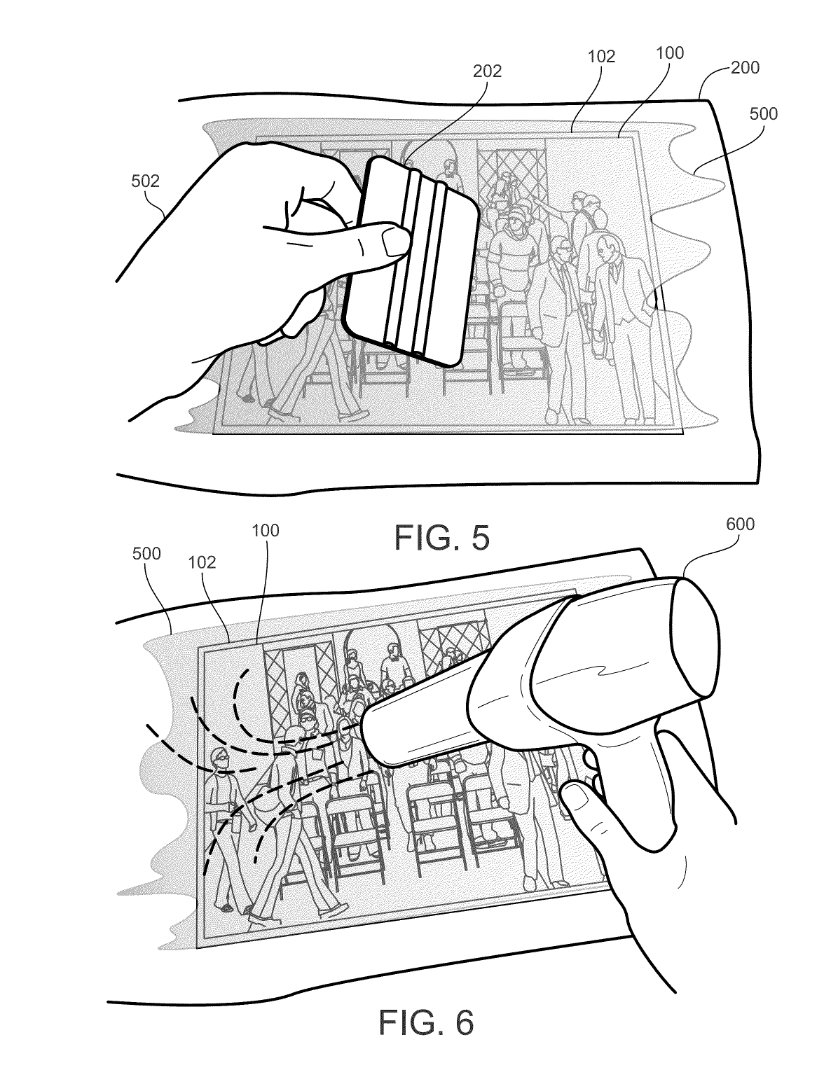

FIG. 5 depicts a perspective view of a person using the squeegee 202 to smooth out brush strokes where the gel 500 was applied. Referring to FIG. 5, the squeegee 202 may be grasped by the user's hand 502 and gently dragged across the paper 102 to smooth the clear gel 500 for coating the paper 102. The foam brush 204 (shown in FIG. 2) may then be cleaned, and the squeegee 202 washed by use of warm water for preparation for later use. It is recommended that cleaning is done soon to avoid the drying of the gel on the foam brush 204 and squeegee 202. Use of the squeegee 202 is only for aesthetics. If the image is not “squeegeed,” the final product may appear with brush strokes.

FIG. 6 depicts a perspective view of drying of the gel 500 in accordance with embodiments of the present subject matter. In this example, a hair dryer 600 is used to expedite the drying of the gel 500. The hair dryer 600 may be set to high heat and low speed, or any other suitable setting. Once the gel 500 is completely dry or substantially dry, it may no longer be tacky and the image 100 may appear clear with no haziness. If a hair dryer 600 is not used, the image 100 may be allowed to dry for 12-24 hours or another suitable time. Alternatively, the image 100 may be dried by any other suitable technique.

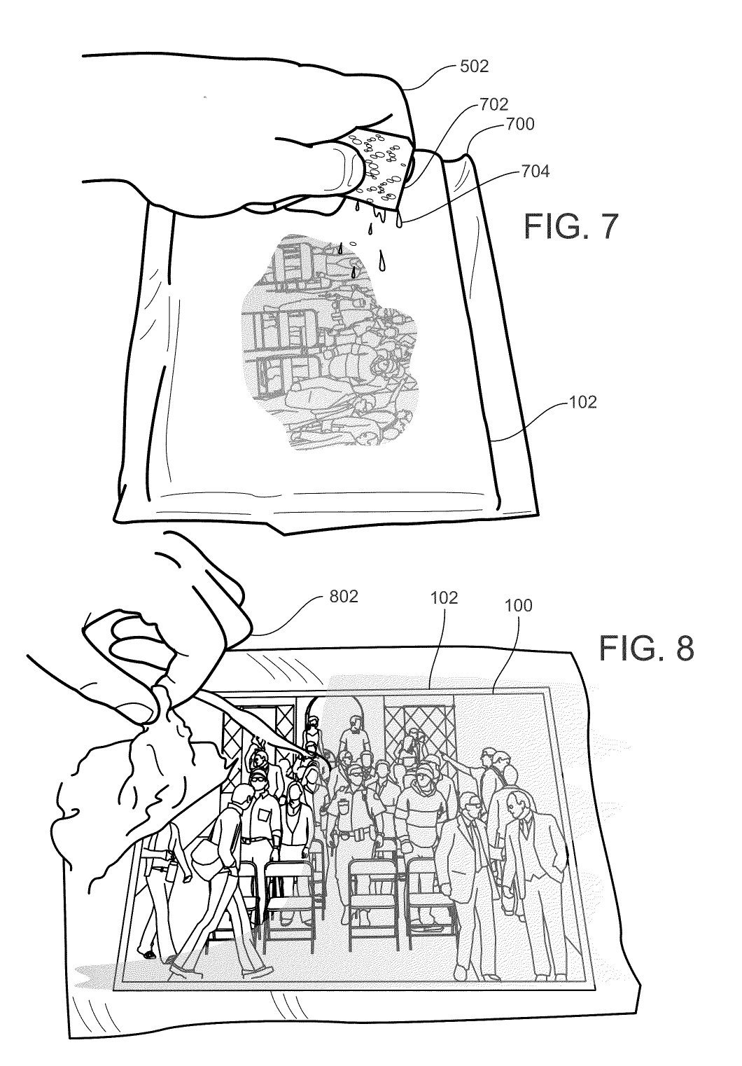

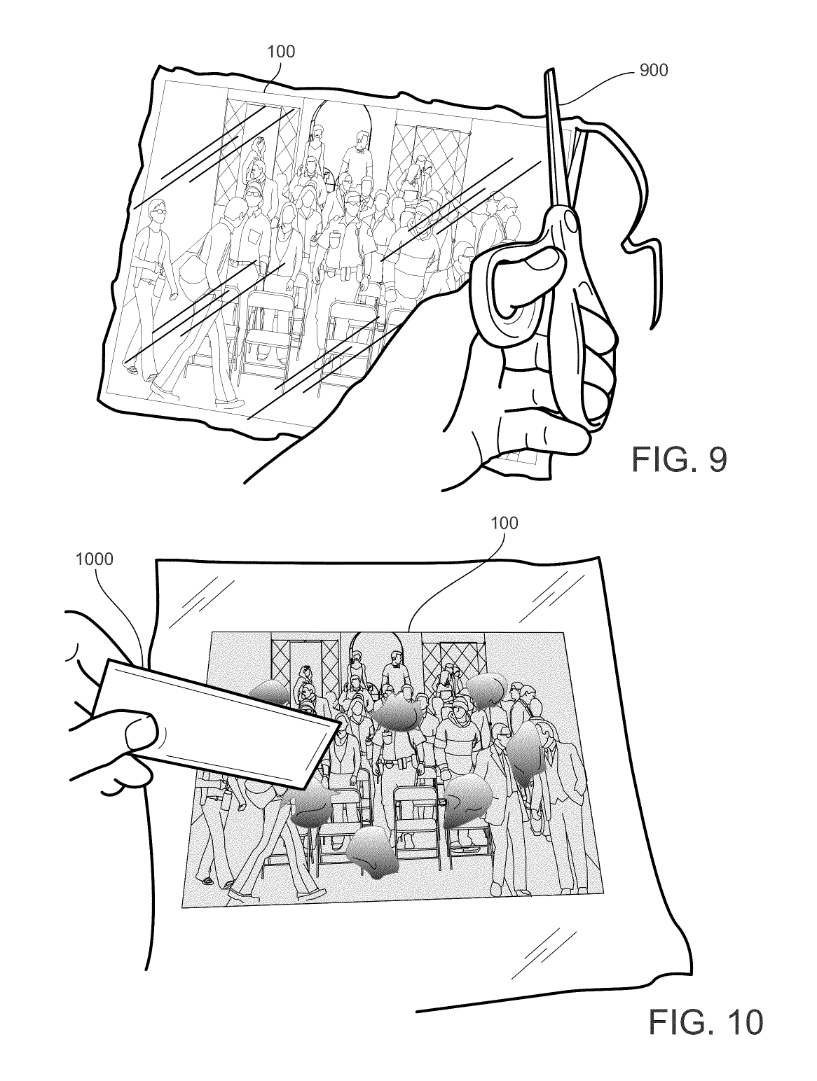

FIGS. 7 and 8 depict perspective views of steps for removing the dissolving paper 102 in accordance with embodiments of the present subject matter. Particularly, referring to FIG. 7, two paper towels 700 laid out for absorbing water. The dissolving paper 102 may be placed with the image side down on top of the paper towels 700. Subsequently, a wet sponge 702 may be gently squeezed over the dissolving paper 102 to release water 704 on the paper 102 until it is all or substantially wet. Now turning to FIG. 8, the image shows a person using his or her fingers 800 to gently rub off and remove the paper 102 from the image. It is noted that care should be taken close to the edges of the paper as this is where tearing is most likely to occur. More water may be added as needed. The goal is to remove most of the paper backing while leaving a thin plastic film with the image 100 on it. Subsequently, the image 100 may be allowed to completely or nearly completely dry. A hair dryer set at high heat and low speed may be used to expedite the drying. Once dry or substantially dry, scissors 900 may be used to remove any rough edges of the paper 102 around the image 100 as shown in FIG. 9, which depicts a perspective view of the user of the scissors 900 for removing portions of the paper 102.

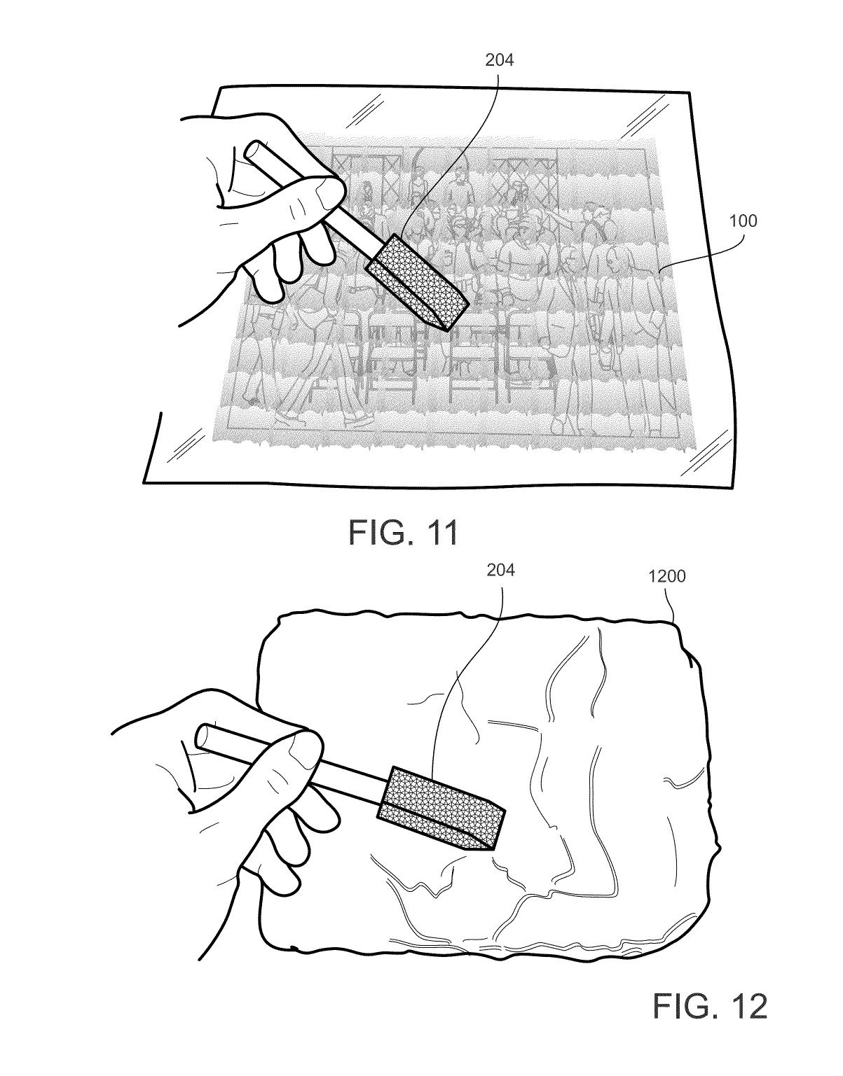

FIGS. 10-14 depict perspective views of applying adhesive to the image 100 and an object surface in accordance with embodiments of the present subject matter. Referring to FIG. 10, to adhere the image 100 onto an object surface such as the surface of a stone, a 10 ml packet of clear gel 1000 can be opened and the gel squeezed onto the back side of the image 100 and an object surface, which is a stone's surface in this example. Many clear drying adhesives may be suitable. The adhesive may be applied to completely or nearly completely cover the entire back of the image and front of the stone, edge to edge. The foam brush 204 may be used to smooth out the gel on the back of the image and the stone's surface as shown in FIGS. 11 and 12, respectively. Subsequently, the foam brush 204 may be cleaned by washing and pat drying it with paper towels.

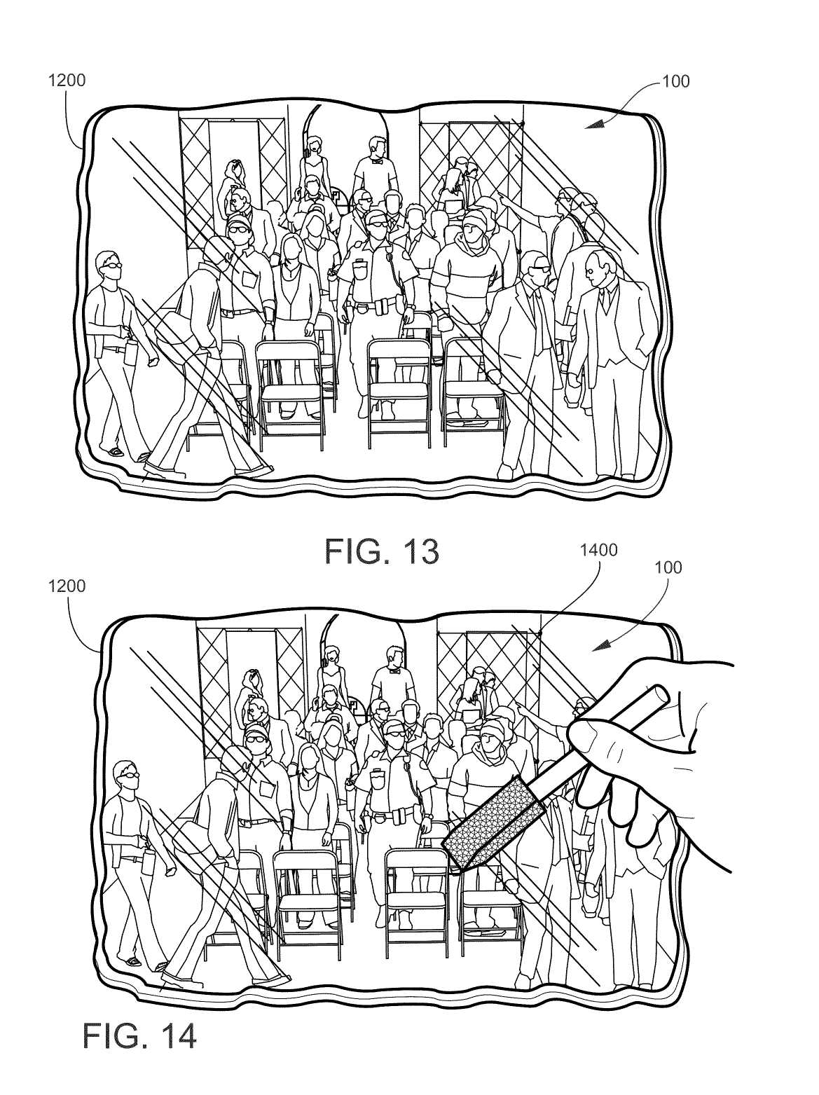

Subsequently, the image 100 may be applied to the stone's 1200 surface with the image 100 side up and the wet gel side down, the result of which is shown in FIG. 13. FIG. 14 shows an image of using a clean and dry foam brush 1400 for removing any air bubbles underneath the image. Also, the brush 1400 may be used to push the image 100 into any crevices and/or textures of the stone's 1200 surface. It is noted that care should be taken because the image may be prone to tearing while the gel is wet. The sides of the image 100 may be wrapped around the edges of the stone 1200, using the foam brush 1400 to gently push the image 100 into crevices. Any excess may be trimmed with scissors. The stone 1200 and image 100 may be allowed to dry for a sufficient time period, such as between about 24 and 48 hours, or any other suitable time period. Further, the edges of the stone 1200 may be painted with any type of acrylic paint or left as is with the image 100 wrapped around it.

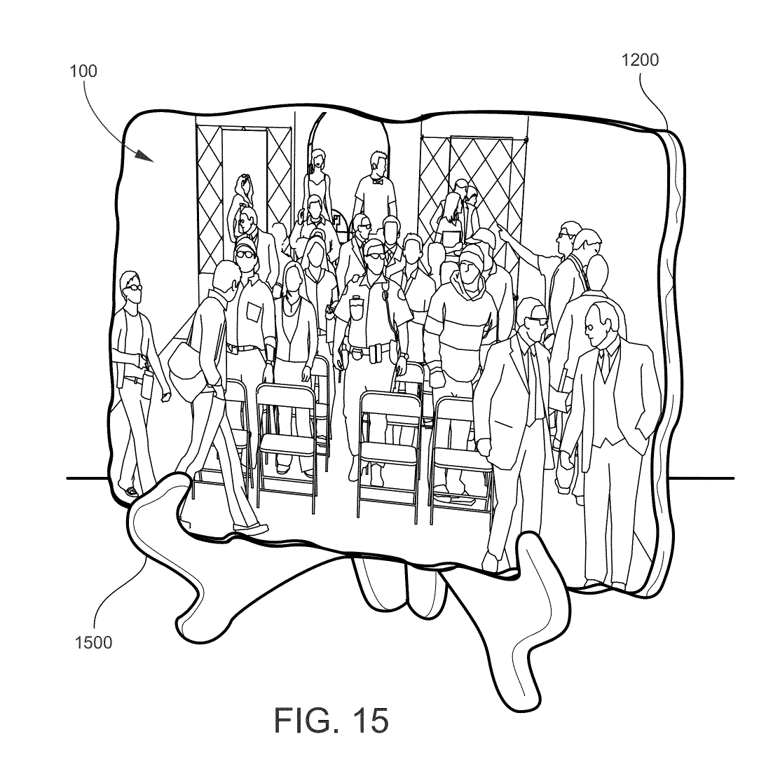

FIG. 15 depicts a perspective view of the stone 1200 with the image 100 placed thereon in a display stand 1500.

The terminology used herein is for the purpose of describing particular embodiments only and is not intended to be limiting of the present subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present subject matter has been presented for purposes of illustration and description, but is not intended to be exhaustive or limited to the subject matter in the form disclosed. Many modifications and variations will be apparent to those of ordinary skill in the art without departing from the scope and spirit of the present subject matter. The embodiment was chosen and described in order to best explain the principles of the subject matter and the practical application, and to enable others of ordinary skill in the art to understand the subject matter for various embodiments with various modifications as are suited to the particular use contemplated.

The descriptions of the various embodiments of the present subject matter have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for transferring an image onto a surface, the method comprising:
printing an image on a dissolving material;
applying clear gel to the printed image;
applying liquid to the dissolving material to remove the dissolving material from the printed image;
coating a backside of the printed image with adhesive; and
contacting the adhesive-covered backside of the printed image to a surface.

2. The method of claim 1, wherein the dissolving material is dissolving paper.

3. The method of claim 1, wherein printing the image comprises using a laser printer to print the image on the dissolving material.

4. The method of claim 1, wherein the clear gel comprises one of polyvinyl acetate, acrylic gel medium, acrylic gesso, acrylic matte medium, acrylic gloss medium, or acrylic-based substance.

5. The method of claim 1, wherein applying clear gel comprises applying a substantially even coat of the clear gel to a front side of the printed image.

6. The method of claim 5, wherein the substantially even coat of clear gel is substantially transparent.

7. The method of claim 1, further comprising drying the clear gel prior to applying liquid to the dissolving material.

8. The method of claim 1, wherein applying liquid to the dissolving material comprises applying water to the dissolving material.

9. The method of claim 1, applying adhesive to the surface.

10. The method of claim 1, wherein contacting the adhesive-covered backside comprises contacting the adhesive-covered backside of the printed image to one of a rock, wood, foam, glass, mirror, metal, and plastic.

11. The method of claim 1, further comprising brushing the printed image on the surface for contacting substantially all the printed image to the surface.

12. A kit for placing an image on a surface, the kit comprising:
dissolving material for print of an image;
clear gel for application to the image printed on the dissolving material; and
adhesive for attached the printed image to a surface.

13. The kit of claim 12, wherein the dissolving material is dissolving paper.

14. The kit of claim 12, wherein the clear gel comprises one of polyvinyl acetate, acrylic gel medium, acrylic gesso, acrylic matte medium, acrylic gloss medium, or an acrylic-based substance.
